(19) United States
(12) Patent Application Publication
(10) Pub. No.: US 2003/0126960 A1
(43) Pub. Date: Jul. 10, 2003

(54) Socket device having an improved driving structure

(76) Inventor: Alex Chen, Taichung Hsien (TW)

Correspondence Address: CHARLES E. BAXLEY, 5th Floor, 59 John Street, New York, NY, 10038, US

(21) Appl. No.: 10/038,399

(22) Filed: Jan. 7, 2002

(51) Int. Cl. B25B 13/06

(52) U.S. Cl. 81/121.1

(57) ABSTRACT

A socket includes a driving portion having an engaging hole formed by a peripheral wall which has a uniform thickness formed through the peripheral portion for avoiding the stress concentration problems occurred in the driving portion of the socket. The driving portion includes an inner peripheral surface and an outer peripheral surface parallel to each other for forming the uniform thickness of the peripheral wall of the socket. The inner peripheral surface and the outer peripheral surface each includes six curved surfaces and six rounded corners.

### BACKGROUND OF THE INVENTION

1. Field of the Invention

The present invention relates to a socket, and more particularly to a socket including a driving portion having an improved driving structure.

2. Description of the Prior Art

As shown in FIGS. 1 and 2, one of the typical sockets comprises a driving end or a driving portion having a circular outer peripheral surface 10 formed thereon, and an engaging hole 11 of a hexagonal cross section formed therein for receiving the typical bolts, nuts, tool extensions, fasteners or the like. Some of the typical sockets further provide a rounded recess 12 formed in each of the corners of the hexagonal engaging hole 11 for preventing stress concentration purposes. However, stress concentration problems may still be occurred more or less in the corner areas 12 of the hexagonal engaging hole 11 of the socket, because of the formation of the hexagonal engaging hole 11 in the circular socket body.

U.S. Pat. No. 5,284,073 to Wright et al. discloses the other typical sockets having a hexagonal engaging hole and having an inner peripheral surface formed into various kinds of rounded or inclined configuration. However, the thickness of the driving portion of the socket is also not uniform and is changed greatly around the outer peripheral driving portion of socket.

The present invention has arisen to mitigate and/or obviate the afore-described disadvantages of the conventional sockets.

### SUMMARY OF THE INVENTION

The primary objective of the present invention is to provide a socket including a driving portion having a uniform thickness for preventing or avoiding stress concentration problems in the driving portion of the socket and having an improved driving structure.

In accordance with one aspect of the invention, there is provided a socket comprising a socket body including a driving portion having an engaging hole formed therein, and having a peripheral wall formed around the engaging hole thereof for forming and defining the engaging hole thereof. The peripheral wall of the driving portion of the socket body includes a peripheral portion having a uniform thickness formed therethrough for preventing or avoiding the stress concentration problems occurred or generated in the driving portion of the socket.

The peripheral wall of the driving portion of the socket body includes an inner peripheral surface formed therein for forming and defining the engaging hole of the driving portion of the socket body, and includes an outer peripheral surface formed thereon.

The inner peripheral surface and the outer peripheral surface of the peripheral wall are parallel to each other, and the inner peripheral surface of the peripheral wall includes six surfaces and six corners for forming and defining a hexagonal cross section to the engaging hole of the driving portion of the socket body.

The six surfaces of the inner peripheral surface of the peripheral wall are preferably convex surfaces, and are preferably slightly convex inward of the engaging hole of the driving portion of the socket body. The six corners of the inner peripheral surface of the peripheral wall are preferably rounded corners. In addition, preferably, the six rounded corners of the inner peripheral surface of the peripheral wall are concave corners for further reducing or preventing or avoiding the stress concentration problems occurred or generated in the driving portion of the socket.

The outer peripheral surface of the peripheral wall includes six surfaces and six corners parallel to the six surfaces and the six corners of the inner peripheral surface of the peripheral wall for forming the uniform thickness of the peripheral wall of the socket body.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a front perspective view of a typical socket;

FIG. 2 is a front view of the driving portion of the typical socket;

FIG. 3 is a front perspective view of a socket in accordance with the present invention;

FIG. 4 is a rear perspective view of the socket in accordance with the present invention; and

FIG. 5 is a front view of the driving portion of the socket in accordance with the present invention.

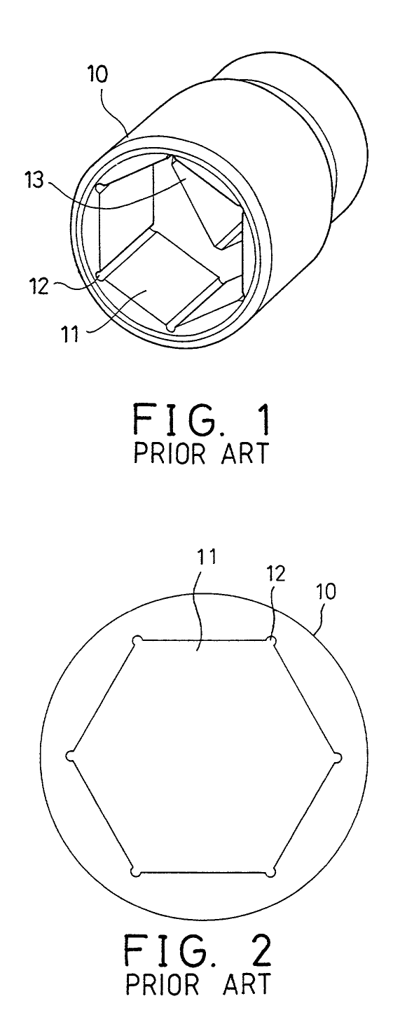

### DETAILED DESCRIPTION OF THE PREFERRED EMBODIMENT

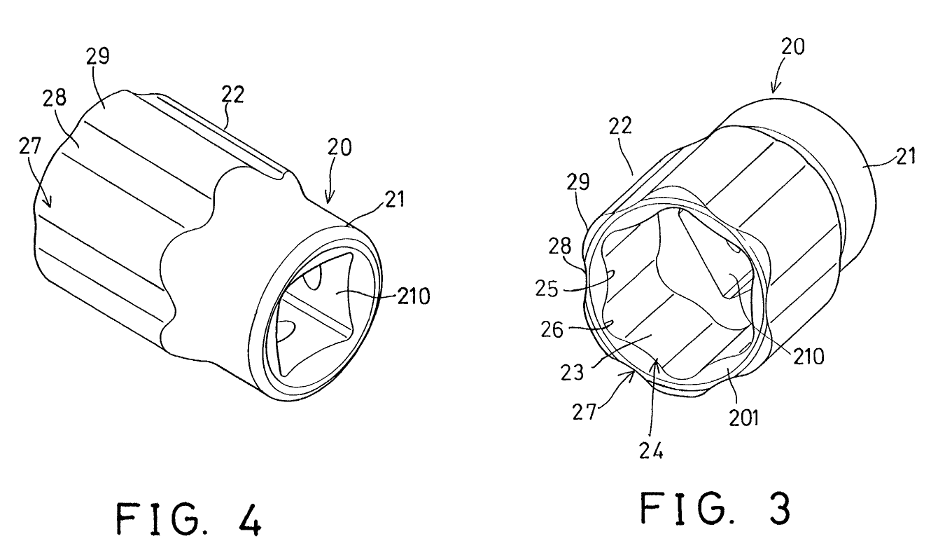

Referring to the drawings, and initially to FIGS. 3 and 4, a socket in accordance with the present invention comprises a socket body 20 including a base end or a rear end 21 having a socket opening 210 formed therein for receiving the driving stems of the other driving tools, such as the tool extensions, the wrenches or the like, and for allowing the socket 10 to be driven and rotated by the tool extensions, or the wrenches, or the other driving tools. The socket body 20 includes a front end or a front portion or a driving portion 22 having an engaging hole 23 formed therein for receiving and for rotating and for driving the bolts, the nuts, the fasteners, the tool extensions, or the like.

The driving portion 22 of the socket body 20 includes an inner peripheral surface 24 and/or a peripheral wall 201 provided therein for forming or defining the engaging hole 23 of the driving portion 22 of the socket body 20. The engaging hole 23 includes a substantially hexagonal cross section having six flat or slightly convex surfaces 25 and having six rounded or concave corners 26 formed therein. For example, the convex surfaces 25 are slightly convex inward of the engaging hole 23 of the socket body 20. The peripheral wall 201 of the driving portion 22 includes an outer peripheral surface 27 having six flat or slightly concave surfaces 28 and having six rounded or convex corners 29 formed therein, and parallel to the six flat or slightly convex surfaces 25 and the six rounded or concave corners 26 of the inner peripheral surface 24 respectively, such that the peripheral wall 201 of the driving portion 22 includes a uniform thickness formed through or around the peripheral portion thereof.

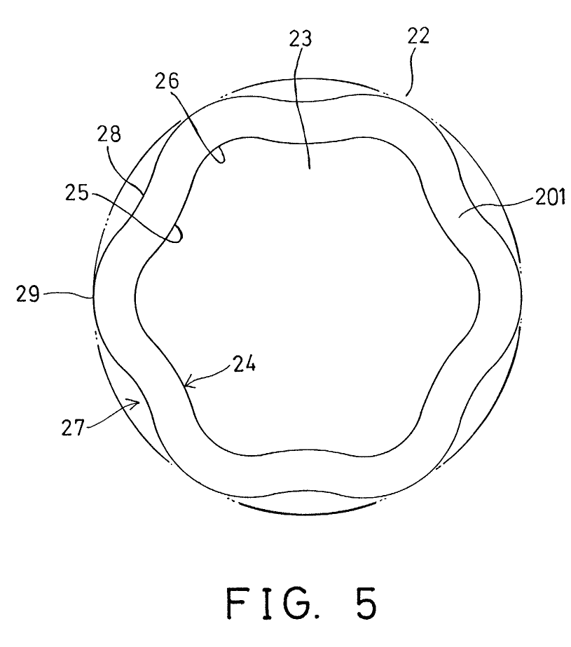

As best shown in FIG. 5, the uniform thickness of the peripheral portion of the peripheral wall 201 of the driving portion 22 may be used for uniformly distributing or dissipating the forces of the fasteners or the other tools applied to the peripheral wall 201 of the driving portion 22 of the socket body 20, and thus for decreasing or diminishing the stress concentration problems in the sockets.

The engaging hole 23 of the driving portion 22 of the socket 20 is shown as having a hexagonal cross section. However, the engaging hole 23 may also be formed into various kinds of shapes, and the socket 20 may include the inner peripheral surface 24 and/or the outer peripheral wall 201, and/or the outer peripheral surface 27 parallel to each other for forming and defining the engaging hole 23 of different or various kinds of shapes.

Accordingly, the socket in accordance with the present invention includes a driving portion having a uniform thickness for preventing or avoiding stress concentration problems in the driving portion of the socket.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A socket comprising:
a socket body including a driving portion having an engaging hole formed therein, and having a peripheral wall formed around said engaging hole thereof for forming and defining said engaging hole thereof,
said peripheral wall of said driving portion of said socket body including a peripheral portion having a uniform thickness formed therethrough.

2. The socket according to claim 1, wherein said peripheral wall of said driving portion of said socket body includes an inner peripheral surface formed therein for forming and defining said engaging hole of said driving portion of said socket body, and includes an outer peripheral surface formed thereon.

3. The socket according to claim 2, wherein said inner peripheral surface and said outer peripheral surface of said peripheral wall are parallel to each other.

4. The socket according to claim 2, wherein said inner peripheral surface of said peripheral wall includes six surfaces and six corners for forming and defining a hexagonal cross section to said engaging hole of said driving portion of said socket body.

5. The socket according to claim 4, wherein said six surfaces of said inner peripheral surface of said peripheral wall are convex surfaces.

6. The socket according to claim 4, wherein said six corners of said inner peripheral surface of said peripheral wall are rounded corners.

7. The socket according to claim 6, wherein said six rounded corners of said inner peripheral surface of said peripheral wall are concave corners.

8. The socket according to claim 2, wherein said outer peripheral surface of said peripheral wall includes six surfaces and six corners parallel to said six surfaces and said six corners of said inner peripheral surface of said peripheral wall.

9. A socket comprising:
a socket body including a driving portion having an engaging hole formed therein, and having an inner peripheral surface formed therein for forming and defining said engaging hole of said driving portion of said socket body, and
said driving portion of said socket body including an outer peripheral surface formed thereon and parallel to said inner peripheral surface of said driving portion of said socket body.

10. The socket according to claim 9, wherein said socket body includes a peripheral wall formed around said engaging hole thereof for forming and defining said engaging hole thereof, said peripheral wall of said driving portion of said socket body includes an inner peripheral portion having said inner peripheral surface formed therein, and includes an outer peripheral portion having said outer peripheral surface formed thereon.

11. The socket according to claim 10, wherein said peripheral wall of said driving portion of said socket body includes a peripheral portion having a uniform thickness formed therethrough.

12. The socket according to claim 9, wherein said inner peripheral surface of said driving portion of said socket body includes six surfaces and six corners for forming and defining a hexagonal cross section to said engaging hole of said driving portion of said socket body.

13. The socket according to claim 12, wherein said six surfaces of said inner peripheral surface of said peripheral wall are convex surfaces.

14. The socket according to claim 12, wherein said six corners of said inner peripheral surface of said peripheral wall are rounded corners.

15. The socket according to claim 14, wherein said six rounded corners of said inner peripheral surface of said peripheral wall are concave corners.

16. The socket according to claim 12, wherein said outer peripheral surface of said peripheral wall includes six surfaces and six corners parallel to said six surfaces and said six corners of said inner peripheral surface of said peripheral wall.

17. A socket comprising:
a socket body including a first end having a socket opening formed therein for receiving driving tools,
said socket body including a second end having a driving portion formed thereon and having an engaging hole formed therein, and having an inner peripheral surface formed therein for forming and defining said engaging hole of said driving portion of said socket body, and
said driving portion of said socket body including an outer peripheral surface formed thereon and parallel to said inner peripheral surface of said driving portion of said socket body.

18. The socket according to claim 17, wherein said inner peripheral surface of said driving portion of said socket body includes six surfaces and six corners for forming and defining a hexagonal cross section to said engaging hole of said driving portion of said socket body, said outer peripheral surface of said driving portion includes six surfaces and six corners parallel to said six surfaces and said six corners of said inner peripheral surface of said driving portion of said socket body.
